(19) United States
(12) Patent Application Publication
(10) Pub. No.: US 2014/0020587 A1
(43) Pub. Date: Jan. 23, 2014

(54) EMBEDDING DATA WITH OFFSET PRINTING

(71) Applicant: Kurt M. Sanger, Rochester, NY (US)

(72) Inventor: Kurt M. Sanger, Rochester, NY (US)

(21) Appl. No.: 13/553,096

(22) Filed: Jul. 19, 2012

(51) Int. Cl. B41F 13/193

(52) U.S. Cl. 101/492

(57) ABSTRACT

Embedding data in printed image features on a receiver printed with an offset printing process includes a first offset printing member (240) for forming an image (320) on the first offset printing member. A second offset printing member (260) is roughened in one region (280) of the second offset printing member within a boundary of an image feature on the first offset printing member to embed data (330). Ink is applied to the first offset printing member and transferred from the first offset printing member to the second offset printing member. The ink from the second offset printing member is applied to a receiver (305) and the embedded data is printed within the boundary of the at least one image feature transferred to the receiver.

### CROSS REFERENCE TO RELATED APPLICATIONS

Reference is made to commonly-assigned copending U.S. patent application Ser. No. ______ (Attorney Docket No. K001185US01NAB), filed herewith, entitled EMBEDDING DATA WITH OFFSET PRINTING, by Sanger; U.S. patent application Ser. No. 13/017,260, filed Jan. 31, 2011, entitled EMBEDDING DATA PRINTED IN SOLID AREAS, by Sanger; U.S. patent application Ser. No. 13/017,300, filed Jan. 31, 2011, entitled EMBEDDING DATA INTO SOLID AREAS, TEXT OR LINEWORK, by Sanger et al.; U.S. patent application Ser. No. 13/185,846, filed Jul. 19, 2011, entitled EMBEDDING DATA IN A HALFTONE IMAGE, by Sanger; the disclosures of which are incorporated herein.

### FIELD OF THE INVENTION

This invention pertains in general to offset printing and in particular to embedding data in solid printing areas.

### BACKGROUND OF THE INVENTION

It is difficult to embed data in solid graphical objects. Copending commonly-assigned U.S. patent application Ser. Nos. 13/017,260; 13/017,300; and 13/185,846 describe a process which embeds data in solid objects printed with flexography. The embedded data in solid flexographic prints is accomplished by roughening the surface of a relief member.

Copending commonly-assigned U.S. patent application Ser. Nos. 13/017,260; 13/017,300; and 13/185,846 show the original idea as it applies to flexography. Given a rubber relief plate with a surface pattern in the solid objects on the relief plate, the ink transferred to the receiver is varied by the surface pattern.

In offset lithography it is well known that the solid printed density is dependent upon the roughness of the receiver. Walker and Fetsco, “A Concept of Ink Transfer in Printing”, American Inkmaker, Vol. 33, Issue 12, pp. 38-44 and 69-71, National Assoc of Printing Ink Manufacturers, December (1955), showed that the fraction of ink transferred or printed density varies by the roughness of the receiver. De Grace and Mangin, “A Mechanistic Approach to Ink Transfer Part 1: Effect of Substrate Properties and Press Conditions,” Advances in Printing Science and Technology, pp. 312-332, Pentech, (1984), showed that printed density on Polyester support also varied as a function of surface roughness. Langerstadt and Kolseth, “Influence of Surface Energetics on Ink Transfer in Flexo Printing,” Advances in Printing Science and Technology, Issue 23, pp. 269-299, Elsevier, (1995), determined that surface roughness of paper receivers was more important than treating the paper to change its surface energy. While variations in printing density due to receiver roughness is well known in the art, the ability to create a similar affect by changing the local roughness of an offset rubber blanket was surprising. In addition by using photolithographic techniques to pattern a photopolymer flexographic plate and using the patterned photopolymer flexographic plate as the offset printing member one is able to create fine variations in the local density and variations in structure within printed solid areas.

In an offset printing process a rubber plate or blanket is used to transfer the ink from a plate to the receiver. The plate may be a lithographic plate. The plate may be a gravure plate. The mechanism of ink transfer from the rubber blanket to the receiver is identical to the flexographic process. The difference between an offset printing process and the flexographic printing process is that the image is applied first to an offset printing member and then transferred to the receiver. In offset gravure printing the ink is applied to a blanket or offset rubber roller which then transfers the image to the receiver. One may compare offset gravure to flexography where one replaces the anilox roll in flexography with the etched gravure cylinder, then replaces the patterned flexographic plate with a plain rubber roller. The invention works in offset gravure by replacing the plain rubber roller with a flexographic plate with a patterned roughened surface.

In pad printing a gravure plate, an engraving, a rubber stamp, or a raised relief, is used to transfer ink to a rubber pad, then to the item to be printed. The pad may be shaped to conform to the item or otherwise distort the image on the plate such that the image prints properly on the non-flat planar object. The present invention selectively roughens the surface of the pad to embed data in solid areas of the print.

The surface roughness of the offset pad, roller, or offset printing member may be modified by molding, ablating, or etching. The surface roughness may also be created by depositing, printing, or imaging additional materials to the offset printing member. The offset printing member may also be formed from a photopolymer and the surface roughness may be modified by imaging through a fine mask. Multiple surface patterns may be used to roughen the surface in the area of solid objects on the printing plate.

Very few inventions are described for embedding data in solid printed objects. U.S. Pat. No. 7,555,139 (Rhoads et al.) encodes data by changing the width of lines and text characters. U.S. Pat. No. 6,449,377 (Rhoads) discloses varying line to line spacing to encode data. U.S. Pat. No. 5,761,686 (Bloomberg) adds encoded features which are of the same relative size and spacing as the text in a print to camouflage the encoded data. Most of these change the shape of the object, or change the line width.

There are many advantages to encoding data into printed works. One may wish to encode copyright information, additional information about a product, a remote internet address or link, or encrypted data to indicate authenticity or make it more difficult to copy. One common data encoding method is to embed a watermark within the image. U.S. Pat. No. 7,174,031 (Rhoads et al.) list many methods of encoding data in images. In addition it discusses many additional uses for encoded data.

U.S. Publication No. 2008/0019559 (Wang et al.) modulates a halftone dot with a screened high frequency pattern. Wang et al. (2008/0019559) modulate each pixel printed on an electrophotographic printer using a different halftone texture. This causes a visible seam between different halftone techniques that creates the visible watermark on the print. Wang et al. (2008/0019559) teaches that “Halftoning techniques are necessary because the physical processes involved are binary in nature or the processes have been restricted to binary operation for reason of cost, speed-memory, or stability in the presence of process fluctuations. Examples of such processes are: most printing presses; ink jet printers; binary cathode ray tube displays; and laser xerography.” [pg. 3 para. 0036]. Adding a high frequency screen to the halftone dot reduces its dot area requiring an additional dot gain table and the printing of a larger dot. Printing a larger dot is a disadvantage in relief printing.

There are numerous inventions for embedding data in halftone images. For example Wang et al. (2008/0019559) also state “Examples of AM-FM halftones include “green-noise” halftones, halftones on space filling curves, and halftones with texture control”, [pg. 3 para. 0042]. Texture control describes the print visibility of high frequency FM noise and sharpness of FM prints verses the visibility of the AM Halftone especially in the highlight areas of the print. The AM-FM Halftoning technique replaces AM screening with FM screening in the highlight areas.

U.S. Publication No. 2010/0060943 (Monga et al.) describes decoding message data embedded in an image print using halftone dot orientation. Bulan et al., “Data Embedding In Hardcopy Images Via Halftone-Dot Orientation Modulation”, Proc of SPIE-IS&T Electronic Imaging, Vol. 6819, (2008), embed data in a print by modulating the orientation of an elliptical halftone dot.

U.S. Pat. No. 7,554,699 (Wang et al.) modulates printed shadow images with hybrid halftone dots consisting of amplitude modulated (AM) dots with frequency modulation (FM).

Suh et al., “Printer Mechanism-Level Data Information Embedding and Extraction for Halftone Documents—New Results”, Purdue University, embed data in a halftone image by modulating the halftone dot position.

Oztan and Sharma, “Multiplexed Clustered-Dot Halftone Watermarks Using Bi-Directional Phase Modulation and Detection”, Proc. 2010 IEEE 17^{th} International Conference on Image Processing, September 2010, embed watermarks by shifting the phase of the halftone pattern in the area of the watermark. This is another form of moving the centroid of the halftone dots.

U.S. Pat. No. 7,436,977 (Wang et al.) describe using a first stochastic screen in areas outside of a watermark, with a second stochastic screen in areas within the watermark, where the second stochastic screen is multi-partitioned and at least one partition is orthogonal to a partition of the first screen.

U.S. Pat. No. 7,286,685 (Brunk et al.) embed a watermark by modifying the threshold of an error diffusion process when screening an image. Brunk et al. embed the watermark in the error signal of the printed image.

U.S. Publication No. 2008/0134912 (Golan) describes a method of embossing recesses on a substrate to embed a hidden image. U.S. Publication No. 2007/0296203 (Golan) describes using a laser to create recesses on a substrate and embed a hidden image. Golan describes embossing the substrate or receiver and does not disclose varying printed solid densities by selectively roughening the receiver. Golan does not suggest that we may selectively roughen the support or an offset printing member to embed data.

It is an advantage of the present invention in providing a simple mechanism for embedding data in printed work using existing offset printing equipment with little incremental cost. It is an advantage of the present invention that the invention works across many different printing methods so that customers may apply the invention to the method which is best for their application. It is an advantage of the present invention that it works across many different printing methods as each method enables use of the invention on different receivers such as flat sheets, corrugated stock, paper, coated paper, Aluminum, Aluminum cans, metallic films, plastics, plastic bottles, polymer films, foil films, bottle caps, and numerous objects.

### SUMMARY OF THE INVENTION

Briefly, according to one aspect of the present invention embedding data in printed image features on a receiver printed with an offset printing process includes a first offset printing member for forming an image on the first offset printing member. A second offset printing member is roughened in one region of the second offset printing member within a boundary of an image feature on the first offset printing member to embed data Ink is applied to the first offset printing member and transferred from the first offset printing member to the second offset printing member. The ink from the second offset printing member is applied to a receiver and the embedded data is printed within the boundary of the at least one image feature transferred to the receiver.

This idea applies the concept to offset printing processes such as offset lithography, offset flexography, offset gravure, and pad printing.

The invention works by selectively roughening the surface of the offset blanket or rubber transfer plate. Selectively roughening the surface of the blanket changes the transfer of ink to the receiver. Changing the surface of the blanket in register to solid image areas enables us to embed data in the print. Multiple surface patterns may be used to embed multiple bits per unit area. For instance a 12 point font character may be divided into top, bottom, left and right areas. Then using four surface patterns in one each of four areas enables us to encode 16 bits of data into a single printed solid character. The roughened area of the offset printing member may be larger than the solid image object in order to reduce the registration requirements.

The invention and its objects and advantages will become more apparent in the detailed description of the preferred embodiment presented below.

### BRIEF DESCRIPTION OF THE DRAWINGS

FIG. 1 is a prior art flexographic printer.

FIG. 2 is an offset gravure printer embodiment of the present invention.

FIG. 3 is a micrograph image of printed embedded data using the present invention.

FIG. 4a depicts the outline of a letter ‘m’ with a first solid surface.

FIG. 4b depicts the outline of a letter ‘m’ with a second surface pattern.

FIG. 4c is an expanded view of the second surface feature.

FIG. 4d depicts the outline of a letter ‘m’ with a third surface pattern.

FIG. 4e depicts the outline of a letter ‘m’ with a fourth surface pattern.

FIG. 4f is an expanded view of the fourth surface feature.

FIG. 5 shows a local area containing human and machine readable roughened surface features.

FIG. 6 is an embodiment of the present invention using an offset pad printer.

FIG. 7 is an embodiment of the present invention using an offset lithographic press.

FIG. 8 is an embodiment of the present invention using an offset inkjet printer.

FIG. 9 is an embodiment of the present invention using an offset liquid toner electrophotographic printer.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

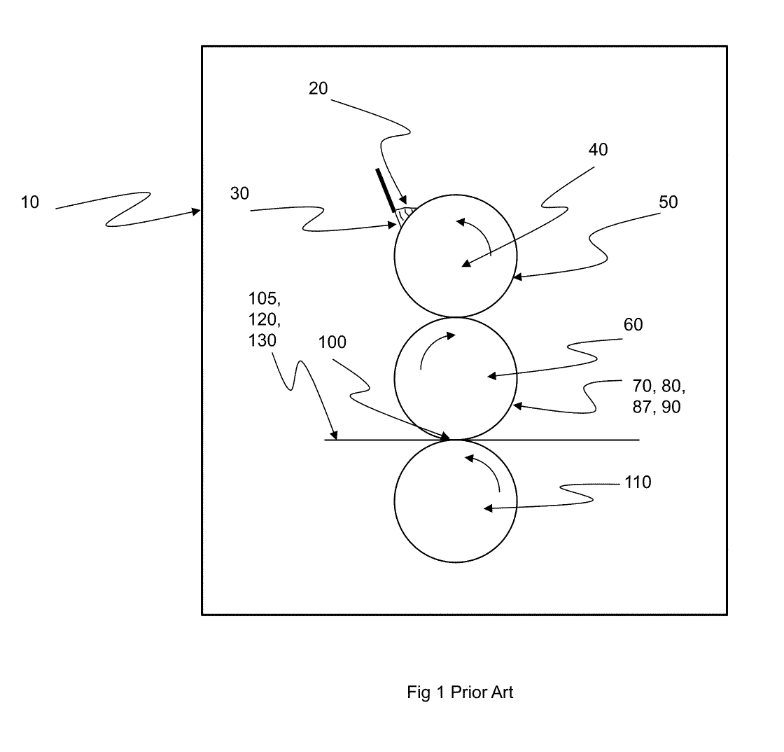

Referring now to FIG. 1 showing a prior art flexographic printer, 10, adapted to embed data in solid image features 90 by modifying the surface of the flexographic plate 70. Ink reservoir 20 is filled with ink against an anilox roller 40 containing an anilox patterned surface 50. Doctor blade 30 skives the ink so that it is primarily filling the anilox patterned surface 50. Filled anilox roll 40 rotates to make contact to the plate roller 60 containing a flexographic printing plate 70 with a raised relief printing surface 80. Raised relief printing surface 80 is previously formed with an image to be printed. Image to be printed contains solid image features 90. Data to be embedded 87 is embedded in the solid features 90 by modifying the surface of the flexographic plate 70 as disclosed by copending commonly-assigned U.S. patent application Ser. Nos. 13/017,260; 13/017,300; and 13/185,846.

Plate roller 60 then rotates to the nip 100 position making contact with a receiver 105 engaged between the printing plate 70 and the impression roller 110. The image is transferred to the receiver 105 creating printed image 120 with embedded data 130.

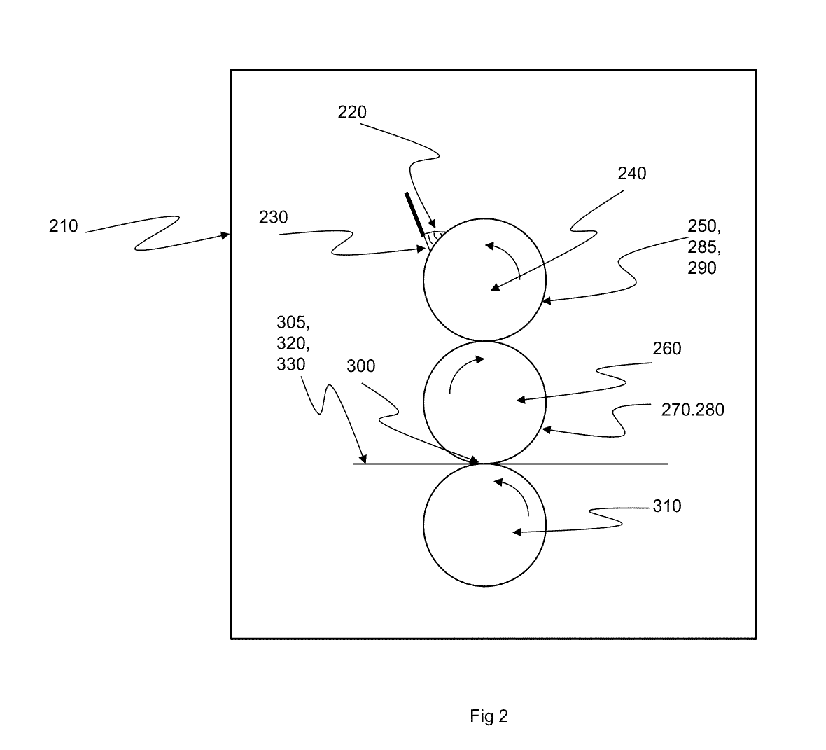

Referring now to FIG. 2 which shows an embodiment of the present invention. FIG. 2 shows an offset gravure printer 210 with an ink reservoir 220 located against a gravure cylinder 240 with an engraved image surface 250. Doctor blade 230 skives the ink so that it is primarily filling the gravure patterned surface 250. Filled gravure cylinder 240 rotates to make contact to an offset roller 260 containing a solid rubber offset roller surface 270 thereby transferring the ink image from the engraved surface 250 to the offset roller 260. Engraved surface 250 contains image areas of substantially solid image features 290 of the image 285 to be printed. The gravure cylinder is a first offset printing member with the image 285. Note that gravure printing uses engraved cells of various depths to implement a tone scale in the printed image. For solid areas the maximum cell depth is used to deliver enough ink to substantially cover the local area of the print. For solid areas this is similar to the anilox pattern used to deliver ink to the flexographic printing plate. In the present invention a roughened area 280 is created on the offset roller 260 surface 270 corresponding to solid image features 290 to embed data. Offset roller 260 is a second offset printing member with a roughened surface.

Offset roller 260 then rotates to the nip 300 position making contact with a receiver 305 web engaged between the offset roller surface 270 and the impression roller 310. The ink image 285 is transferred to the receiver web 305 creating printed image 320 with embedded data 330.

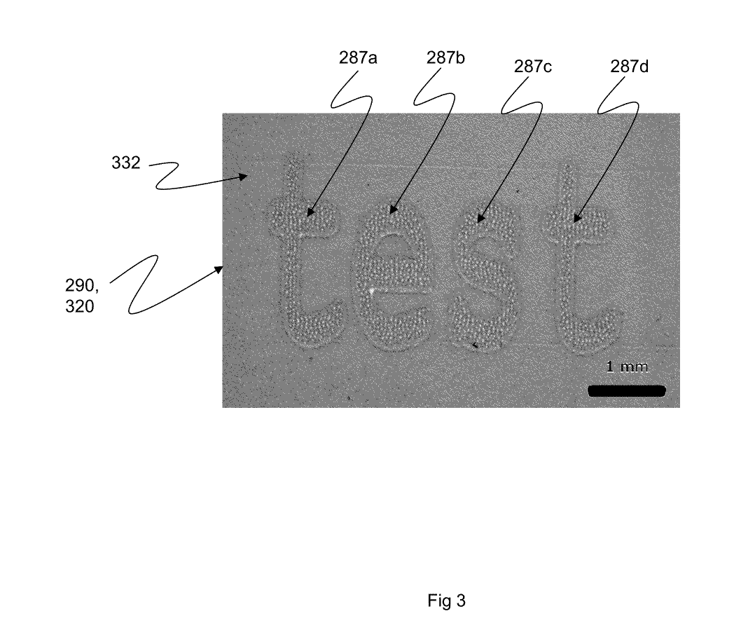

FIG. 3 is a micrograph of a solid image feature 290 of a printed image 320 with embedded data 287a, 287b, 287c, and 287d. In this example the embedded data spells the word “test.” One skilled in the art will recognize that the data may be embedded in machine readable form or in human readable form. FIG. 3 was printed with a gravure cylinder engraved with a solid pattern of 1200 cells per inch and a cell volume of 2 BCM/in² using an offset roller composed of a photopolymer consisting of a styrene-butadiene block copolymer with a selectively roughened surface pattern. The selected surface pattern used for the background 332 consists of a checkerboard pattern with 5 um high by 10 um wide rectangles with a maximum relief of 10 um. The selected surface pattern used for the embedded data 287a-d was a solid surface. Many different patterns on the order of 1 to 30 um wide by 1 to 30 um tall may be used to embed multiple levels of information at each location. For instance in FIG. 3 the top of the letter ‘t’ 287a may be created using a solid pattern while the bottom of the letter ‘t’ 287a may be created with a third pattern enabling us to encode 2 bits of information in the top and 2 bits of information in the bottom of the character.

The embedded data may be recovered by viewing the print at different magnifications. A 10× loop, and hand held 100× microscope, or a lab microscope with differing amounts of magnification may be used. In addition the print may be scanned at high resolution preferable between 1200 and 2400 dpi. The embedded data may be visible at different angles of incidence. Different light sources, different colored light, or coherent radiation to view the embedded data within the print may be used.

Gravure cylinders with lesser cell count such as 75 to 300 cells per inch may be used. Gravure cylinders with differing cell volume such as 0.9 to 6 BCM/in² may be used.

The roughened surface has a depth less than 15 um and preferably between 2 and 6 um.

The engagement between the gravure cylinder and the offset roller is 0.002 inches past where to the two rollers just start to touch. The engagement between the offset roller and the web and impression roller is also 0.002 inches past where the image transfer starts to take place.

The invention may be used by applying embedded data substantially everywhere on the offset roller surface 270 so that all solid image features 290 on the image 285 on the gravure cylinder 240 prints the embedded data. This alleviates the need to register the offset roller surface 270 with the gravure cylinder surface 250. Embedded data may include the printer's name, the machine identifier, the printing date or a portion of the printing date such as the week and year. Embedded data may include an identifier to a data base with additional information on the printing or the product. The web may consist of a roll of paper, a roll of film, a polymer, a metal layer, a roll of label stock or any printable receiver.

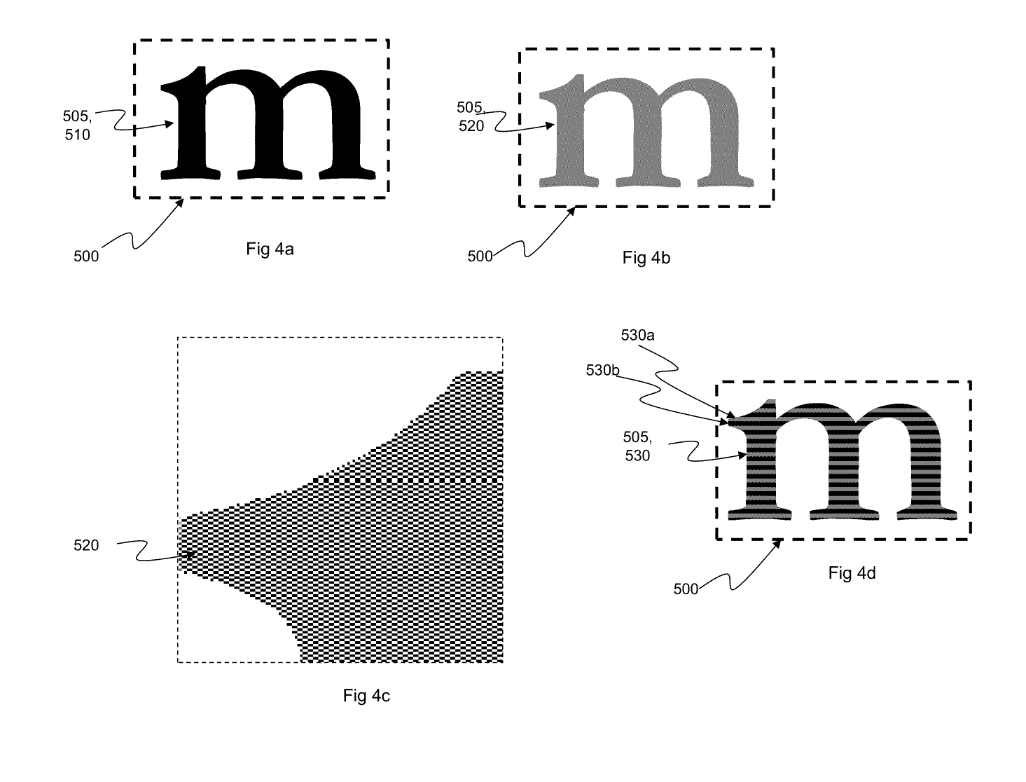

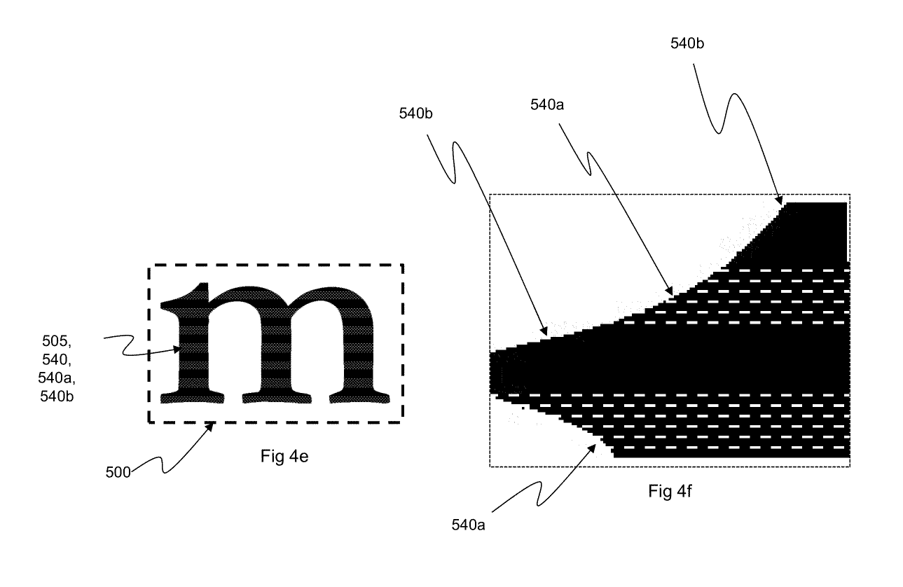

The surface patterns on the offset roller may be patterned in many different ways as shown in FIGS. 4a-4f. FIG. 4a shows the outline of a letter ‘m’ 505 in a local area 500 with a solid surface pattern 510. Solid surface 510 would be the normal printing method for an offset gravure printer. FIG. 4b shows the outline of the letter ‘m’ 505, in a local area 500 with a second surface pattern 520. Note that the first surface pattern is the normal solid surface. FIG. 4c is an expanded view of the second surface pattern 520. One skilled in the art will realize that the area of the surface patterns on the offset roller may be made larger than the etchings on the gravure cylinder to guarantee that the patterns cover the etched areas on the gravure cylinder. For instance the outline of the whole letter ‘m’ local area 500 may be patterned on the offset roller instead of just the outline of the letter 505.

FIG. 4d shows the outline of a letter ‘m’ 505 in a local area 500 with a third surface pattern 530 composed of two intertwined vertical surface patterns 530a and 530b. One skilled in the art will recognize that one may change the phase of the patterns, or the orientation of the patterns, or the number of patterns within the local area 500 of the letter ‘m’. FIG. 4e is another example of an outline of the letter ‘m’ 505 in a local area 500 with fourth surface pattern 540 composed of two different vertical surface patterns 540a and 540b. FIG. 4f is an expanded view showing surface patterns 540a and 540b.

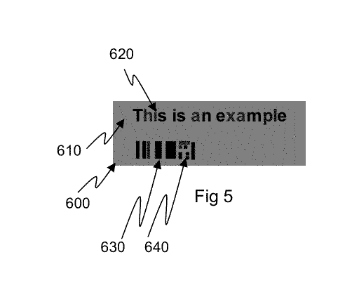

FIG. 5 shows a local area 600 containing a surrounding roughened surface pattern 610 with roughened surface areas 620, 630, and 640. Roughened surface area 620 is in a human readable pattern. Roughened surface 630 is a traditional 1D barcode and roughened surface area 640 is a 2D barcode. Each of these roughened surface areas 620, 630, and 640 may be filled with multiple surface patterns to encode multiple bits per feature.

The roughened surface features on the second offset printing member or offset roller may be created by using laser engraving. The offset roller may be roughened using tooling, sandpaper, or by applying a mask and applying a chemical etch. The offset roller may be a flexographic plate. In this example a Kodak Flexcel NX Plate with a 5 um by 10 um checkerboard surface pattern substantially everywhere except in the outline of the characters of FIG. 3 is used. The offset roller was made by writing a thermal imaging film mask with an IR laser at 830 nm with a 10 um wide by 2 um high spot. Imaging with pixels that are 5 um long by 10 um high every other pixel was turned on and off. The thermal imaging film mask was exposed using all pixels in the solid areas with the embedded data of FIG. 3. The exposed film mask was laminated to an unexposed 1.7 mm thick Flexcel NX Plate. Then a 20 min front exposure through the film mask with UVA light followed by a 10 min back exposure was performed. The film mask was then delaminated and the plate was processed using the normal process through a Mekrom plate processor. The plate was then baked for 2 hours and finished with a UVC and UVA finishing exposure to cure any remaining uncured photopolymer. The plate was then mounted onto the offset roller 260 using 3M 1120 Mounting Tape.

The unaided human eye may resolve periodic patterns up to approximately 4 cycles per mm with a peak in response at 2 cycles per mm. 4 cycles per mm is a period of 250 um. Therefore it is advantageous to create roughened patterns less than 125 um in either direction so that they are difficult to discern by eye. It is more preferable to limit each pattern area to less than 62.5 um by 62.5 um such that the minimum pattern frequency to 8 cycles per mm which is well above the human eye response.

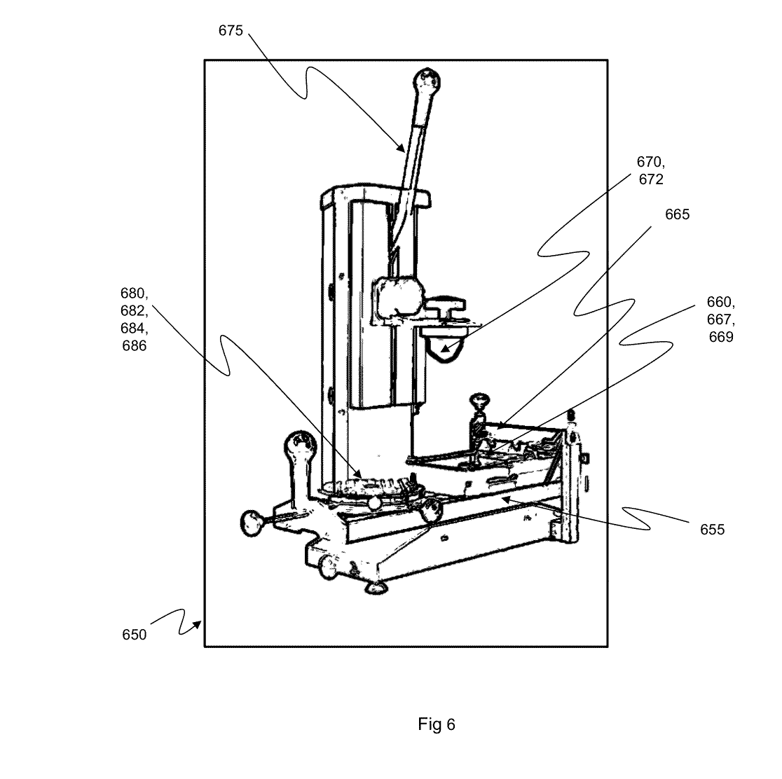

FIG. 6 shows an embodiment of the present invention that embeds data by varying the surface roughness of an offset pad in an offset pad printer 650. Offset pad printer 650 contains slide 655 and a gravure plate 660. The gravure plate 660 is a first offset printing member. The slide is moved to the far right position and ink is applied to the plate. Then the slide is moved to the left causing the knife 665 to evenly spread the ink into the engraved image 667 on the gravure plate 660. The engraved image 667 contains substantially solid areas 669 where data 672 with be embedded. Offset pad 670 with roughened surfaces corresponding to the embedded data 672 is lowered onto the inked gravure plate 660 using lever 675. Offset pad 670 is a second offset printing member. Then the inked offset pad 670 is raised with lever 675. Slide 655 is again positioned to the right causing object 680 placed on receiving platform 682 to be position beneath the pad 670. Lever 675 is then lowered to lower the offset pad 670 onto the object 680 causing the image 667 with embedded data 672 to be printed onto the object 680 forming the printed object 684 with printed embedded data 686.

The offset pad may be molded to the same shape as the object to be printed such that the engraved image is distorted during inking and correctly printed during printing. Offset pads may be molded with embedded data. Offset pads may be laser ablated, etched, or machined to embed data.

The gravure plate 660 in the offset pad printer may be replaced with a flexographic plate such that we have offset flexographic plate pad printer with embedded data by modifying the surface of the offset pad. The gravure plate 660 may be replaced with a raised relief stamp. The invention would then be used by inking the stamp and applying the offset pad with the differentially roughened surfaces to print embedded data.

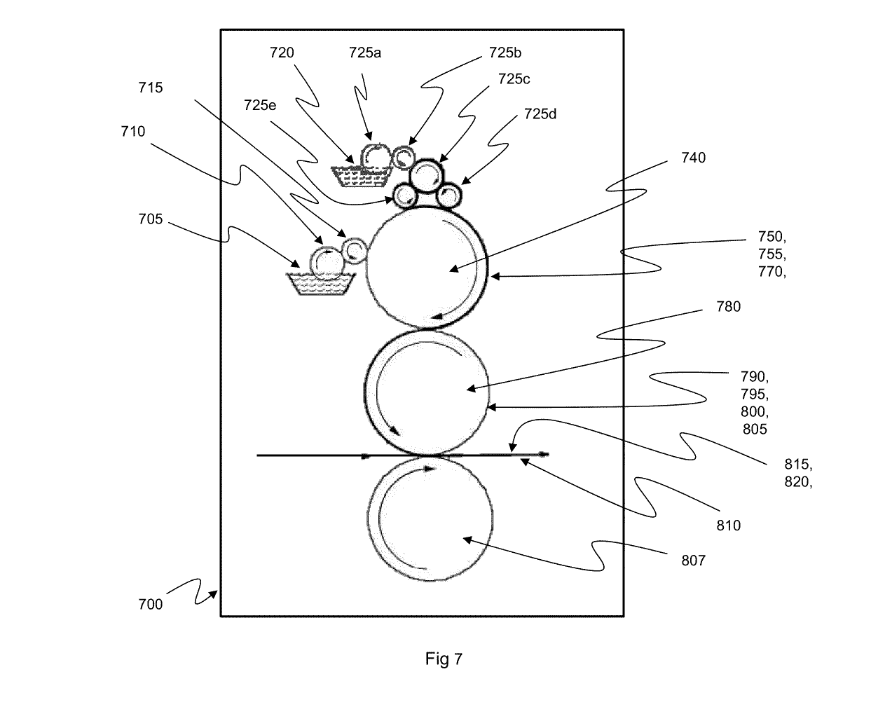

FIG. 7 shows an embodiment of the present invention that embeds data by varying the surface roughness of an offset roller in an offset lithographic press 700. Fountain solution 705 is picked up and transferred to lithographic plate 750 using fountain rollers 710 and 715. Lithographic plate 750 is a first offset printing member. Ink 720 is picked up and distributed by inking rollers 725a-e to the lithographic plate 750. The fountain solution coats the lithographic plate sticking preferentially to the hydrophilic or hydrophobic regions. A water based fountain solution will stick to the hydrophilic plate regions. The ink sticks to the opposite, hydrophobic or hydrophilic regions. An oil based ink will preferentially stick to the hydrophobic regions. The lithographic plate 750 is mounted on the plate cylinder 740 and pre-imaged with an image 755 containing image regions of solid features 770 that print using embedded data 800 with the present invention. The inked plate 750 then rotates to the offset roller 780 containing an offset blanket 790 with a surface 795 that has been modified with different surface roughened patterns 805 correlating to the data one wishes to embed 800 in the areas of the image 755 that are solid features 770. Offset blanket 790 is a second offset printing member.

The offset blanket 790 then picks up the ink from the lithographic plate 750 and transfers the ink to the receiver 810. The receiver is impressed between the offset roller 780 and the impression roller 807 resulting in the print 815 of the image 755 with printed embedded data 820.

One method of registering the offset blanket 790 to the lithographic plate 750 includes mounting an offset blanket on the press. Run the press to ink the blanket. Then emboss the surface of the offset blanket with a tool to roughen the surface with a pattern containing the embedded data in register with the area that the solid image feature transfers to the offset blanket.

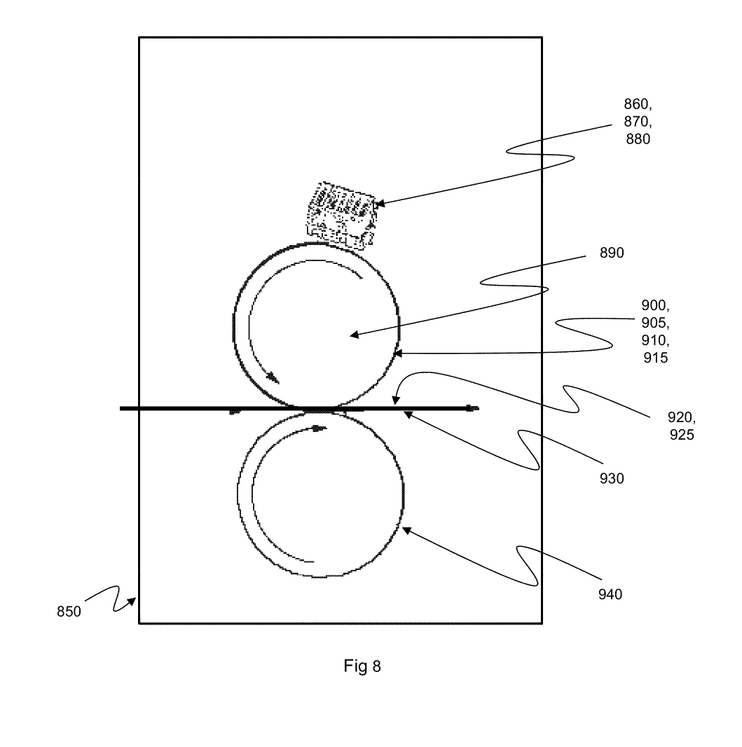

FIG. 8 shows an embodiment of the present invention that embeds data in a print by varying the surface roughness of an offset roller in an offset inkjet printer 850 Inkjet printhead 860 prints ink 870 with image 880 onto offset roller 890 containing an offset blanket 900. Offset blanket 900 has a surface 905 which has been modified in local areas 910 corresponding to solid image areas of image 880. The surface in local areas 910 are modified using various roughened patterns based on embedded data 915.

The offset roller 890 then rotates causing the image to be transferred to a receiver 930 by applying pressure and or heat between the offset roller 890 and the impression roller 940 creating a printed image 920 on the receiver 930 with printed embedded data 925.

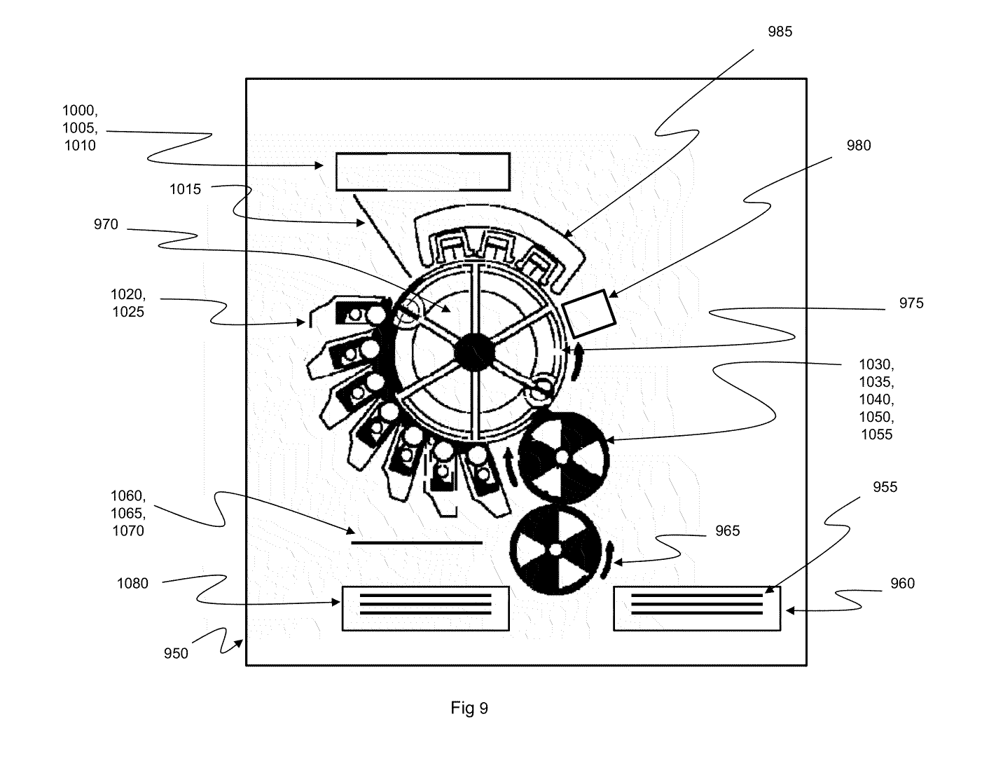

FIG. 9 shows an embodiment of the present invention that embeds data by varying the surface roughness of an offset roller in an offset liquid electrophotographic printer 950. Receiver 955 in a supply cartridge 960 is loaded onto an impression roller 965. Drum roller 970 containing electrostatic belt 975 is cleaned with cleaning station 980. Then the belt is charged in charging station 985. Image data 1000 is sent to laser 1005. Laser beam 1015 is used to expose the electrostatic belt 975 with image data 1000. Charge on the exposed portions of the belt is depleted causing liquid toner 1020 from liquid toner supply 1025 to preferentially stick to the belt 975. Offset roller 1030, with surface 1035, and roughened surfaces 1040, corresponding to solid image areas 1050 of image data 1000 where one wishes to print embedded data 1055, picks up the preferentially deposited liquid toner from the electrostatic belt 975 and deposits the toner onto receiver 955 which is mounted onto the impression roller 965. Heat and or pressure may be used to attach the toner to the receiver. Printed receiver 1060 contains printed solid areas 1065 with printed embedded data 1070. Printed receiver may be placed into take-up tray 1080.

One skilled in the art will recognize that an offset roller may be a rubber roller, a flexographic printing plate, an offset pad, a rubber form, a molded rubber form, a rubber belt, a flexible belt, a developed photopolymer. One skilled in the art will recognize offset printing processes to which the invention applies. For instance the invention applies to offset flexographic printing where we roughen the surface of the offset roller between a Flexographic plate and the receiver.

Ink may be a colored ink containing dyes or pigments. The ink may be a clear overcoat with the embedded data causing a change in reflectance or specularity of the print. The ink may contain metallic particles, or insulating particles, or semiconductive particles. The ink may be a glue where we embed data in the uniformity of the glue layer.

The invention has been described in detail with particular reference to certain preferred embodiments thereof, but it will be understood that variations and modifications can be effected within the scope of the invention.

### PARTS LIST

10 flexographic printer
20 ink reservoir
30 doctor blade
40 anilox roller
50 anilox patterned surface
60 plate roller
70 flexographic plate
80 raised relief printing surface
87 data
90 solid image features
100 nip
105 receiver
110 impression roller
120 printed image
130 embedded data
210 offset gravure printer
220 ink reservoir
230 doctor blade
240 gravure cylinder
250 engraved surface
260 offset roller
270 offset roller surface
280 roughened area
285 image
287a embedded data letter ‘t’
287b embedded data letter ‘e’
287c embedded data letter ‘s’
287d embedded data letter ‘t’
290 solid image features
300 nip
305 receiver
310 impression roller
320 printed image
330 embedded data
332 background
500 local area
505 outline of letter ‘m’
510 solid surface pattern
520 surface pattern
530 surface pattern
530a vertical surface pattern
530b vertical surface pattern
540 surface pattern
540a vertical surface pattern
540b vertical surface pattern
600 local area
610 roughened surface pattern
620 roughened surface area
630 roughened surface area
640 roughened surface area
650 offset pad printer
655 slide
660 gravure plate
665 knife
667 image
669 solid areas
670 offset pad
672 data
675 lever
680 object
682 receiving platform
684 printed object
686 embedded data
700 offset lithographic press
705 fountain solution
710 fountain roller
715 fountain roller
720 ink
725a-e inking rollers
740 plate cylinder
750 lithographic plate
755 image
770 solid features
780 offset roller
790 offset blanket
795 surface
800 embedded data
805 roughened patterns
807 impression roller
810 receiver
815 print
820 printed embedded data
850 offset inkjet printer
860 inkjet printhead
870 ink
880 image
890 offset roller
900 offset blanket
905 surface
910 local area
915 embedded data
920 printed image
925 printed embedded data
930 receiver
940 impression roller
950 offset liquid electrophotographic printer
955 receiver
960 cartridge
965 impression roller
970 drum roller
975 electrostatic belt
980 cleaning station
985 charging station
1000 image data
1005 laser
1015 laser beam
1020 liquid toner
1025 liquid toner supply
1030 offset roller
1035 offset roller surface
1040 roughened surface
1050 solid image areas
1055 embedded data
1060 printed receiver
1065 printed solid areas
1070 printed embedded data
1080 take-up tray

1. A method of embedding data in printed image features on a receiver printed with an offset printing process comprising:
providing a first offset printing member;
forming an image on the first offset printing member;
providing a second offset printing member;
roughening at least one region of a surface of the second offset printing member within a boundary of an image feature on the first offset printing member to embed data;
applying ink to the first offset printing member;
transferring the applied ink from the first offset printing member to the second offset printing member; and
transferring the applied ink from the second offset printing member to a receiver wherein the embedded data is printed within the boundary of the at least one image feature transferred to the receiver.

2. The method of claim 1 wherein the first offset member is selected from a group consisting of a gravure cylinder, offset litho plate, relief member, flexographic plate and rubber stamp.

3. The method of claim 1 wherein the second offset member is selected from a group consisting of a offset lithographic blanket, offset gravure roller, rubber roller, rubber pad, rubber form and compliant offset roller.

4. The method of claim 1 wherein ink is selected from a group consisting a colored ink, a pigmented ink, a dye based ink, a nanometallic ink, an insulating ink, a polymer, a glue and a semiconductor.

5. The method of claim 1 wherein the embedded data is detectable under magnification.

6. The method of claim 1 wherein the surface roughness is on the order of less than 20 um deep and preferably less than 10 um.

7. The method of claim 1 wherein the surface is roughened using a laser.

8. The method of claim 1 wherein the surface is roughened by embossing a pattern.

9. The method of claim 1 wherein the surface is roughened by exposing a photocurable polymer in a pattern.

10. The method of claim 1 wherein the surface is roughened with a predetermined pattern.

11. The method of claim 1 wherein the surface is roughened with more than one predetermined pattern in order to embed multiple levels of information within an image feature boundary.

12. The method of claim 1 wherein the roughened pattern areas are smaller than 125 um by 125 um and preferably smaller than 62.5 um by 62.5 um.

13. The method of claim 1 wherein the boundary of the image feature may be the whole second offset printing member.

14. The method of claim 1 wherein more than one image regions on the second offset printing member is roughened with one or more patterns.

15. The method of claim 1 wherein the first and second offset printing members are held in register to each other.

16. A method of embedding data in printed image features on a receiver printed with an offset printing process comprising:
providing an offset printing member;
roughening at least one region of a surface of the offset printing member to embed data;
applying ink in an image wise fashion to the offset printing member; and
transferring the applied ink from the offset printing member to a receiver wherein the embedded data is printed within the image transferred to the receiver.

17. The method of claim 16 wherein ink is applied in an image wise fashion using a gravure cylinder, an offset lithographic plate, an inkjet printhead, a rubber stamp, or a flexographic plate.

18. The method of claim 16 wherein the image is applied in register to the offset printing member thereby registering the embedded data with the image.

19. The method of claim 16 wherein the offset printing member is an offset gravure roller, an offset lithographic blanket, a rubber transfer roller, or a rubber transfer pad.

20. A method of embedding data in printed image features on a receiver printed with an offset printing process comprising:
providing an offset printing member which is an offset electrostatic belt;
roughening at least one region of a surface of the offset printing member to embed data;
applying a charge in an image wise fashion to the offset electrostatic belt;
applying liquid toner to the imaged offset electrostatic belt; and
transferring the applied liquid toner from the offset electrostatic belt to a receiver wherein the embedded data is printed within the image transferred to the receiver.
